(19) United States
(12) Patent Application Publication
(10) Pub. No.: US 2013/0085903 A1
(43) Pub. Date: Apr. 4, 2013

(54) Mileage Tracker Entry for Mobile Expense Solutions

(71) Applicants: Heather COTTINGHAM, San Francisco, CA (US); Elizabeth Dawn Abraham, Foster City, CA (US); Bopinderjit Singh, Sunnyvale, CA (US)

(72) Inventors: Heather COTTINGHAM, San Francisco, CA (US); Elizabeth Dawn Abraham, Foster City, CA (US); Bopinderjit Singh, Sunnyvale, CA (US)

(73) Assignee: Oracle International Corporation, Redwood Shores, CA (US)

(21) Appl. No.: 13/251,232

(22) Filed: Oct. 1, 2011

(51) Int. Cl. G06Q 10/06

(52) U.S. Cl. 705/30

(57) ABSTRACT

An improved approach is described for implementing an expense solution that includes mileage tracker methods and systems. Mobile devices are integrated into an expense solutions architecture so that expense-related data can be captured, created, entered, and/or edited on the mobile device. This permits the user to generate expense line entries more in alignment with the location/way that many expense are actually generated, e.g., while the user is away from the office computer.

### RELATED APPLICATIONS

The present application is related to co-pending U.S. Ser. Nos. ______, Attorney Docket Nos. ORA120108-US-NP-1, ORA120108-US-NP-2, ORA120109-US-NP-1, ORA120109-US-NP-2, and ORA120301-US-NP, filed on even date herewith, which are all hereby incorporated by reference in their entirety.

### FIELD

The disclosure pertains to the field of expense solutions.

### BACKGROUND

There is a need for employees in just about every type of organization or company to generate expense reports to reimbursable expenditures. These expense reports are filled out by the employee and/or the employee's assistants to provide information that is required in order to obtain reimbursement for certain types of expenses that may have been incurred by the employee. For example, travel expenses and meal expenses are typical examples of the types of expenses for which expense reports are created.

The problem being addressed by the current disclosure is that conventional expense reporting solutions that are based on an enterprise application are all tied to the user having to log in and manually access the enterprise application through a computer system. This approach is illustrated in FIG. 1, which illustrates that the conventional enterprise solution to expense management relies upon a user to access some sort of workstation/computer 102 that is within a company network 106 to manually generate expense report entries 104. The expense report entries 104 are then provided to an application server 108, where the data can then be processed and stored in a database 110, e.g., to create an expense report.

The problem with this approach is that it ignores the fact that many types of expenses occur while the user is away from his computer, and therefore the prior art architecture of FIG. 1 forces the user to delay entry of the expense lines until the user can later access a workstation or computer 102 that is within the company network. Moreover, the above approach requires the costly and time-consuming approach of having the user manually enter all information required for the expense report.

Therefore, there is a need for an improved approach to allow a user to enter and edit expense entries.

### SUMMARY

Some embodiments pertain to an expense solution that includes a mileage tracker method and system. According to some embodiments of the invention, mobile devices are integrated into the expense solutions architecture such that expense-related data can be captured, created, entered, and/or edited on the mobile device. This permits the user to generate expense line entries more in alignment with the location/way that many expense are actually generated, e.g., while the user is away from the office computer. Even while away from the office, the user will likely be with his/her mobile phone and it would be convenient for the user to be able to enter expense lines using the mobile device at, or very near, to the time/location at which the expense are actually being incurred, instead of waiting until the user returns back to the work computer to enter the expenses.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE DRAWINGS

FIG. 1 illustrates a prior art system for generating expense report entries.

FIG. 2 illustrates a system for processing expense entries according to some embodiments of the invention.

FIG. 3 illustrates components of a mobile device for processing expense entries according to some embodiments of the invention.

FIG. 4 illustrates components of a server for processing expense entries created at a mobile device according to some embodiments of the invention.

FIG. 5 illustrates a flowchart of an approach for launching a mobile device for processing expense entries according to some embodiments of the invention.

FIG. 6 illustrates reference data that may be employed in a system for processing expense entries according to some embodiments of the invention.

FIG. 7 illustrates a flowchart of an approach for generating expense entries according to some embodiments of the invention.

FIG. 8 illustrates a flowchart of an approach for uploading expense entries created at a mobile device to a server according to some embodiments of the invention.

FIG. 9 illustrates a flowchart of an approach for processing expense entries created at a mobile device that have been sent to a server according to some embodiments of the invention.

FIG. 10 illustrates entry modes for processing expense entries according to some embodiments of the invention.

FIG. 11 illustrates an example interface on a mobile device for processing expense entries according to some embodiments of the invention.

FIG. 12 illustrates a flowchart of an approach for implementing a quick entry mode at a mobile device according to some embodiments of the invention.

FIG. 13 illustrates an example interface for implementing a quick entry mode at a mobile device according to some embodiments of the invention.

FIG. 14 illustrates a flowchart of an approach for implementing a voice entry mode at a mobile device according to some embodiments of the invention.

FIGS. 15A-F illustrate example interfaces for implementing a voice entry mode at a mobile device according to some embodiments of the invention.

FIG. 16 illustrates a flowchart of an approach for implementing a calendar entry mode at a mobile device according to some embodiments of the invention.

FIG. 17 illustrates an example calendar entry mode at a mobile device according to some embodiments of the invention.

FIG. 18 illustrates an example approach for implementing an image entry mode at a mobile device according to some embodiments of the invention.

FIG. 19 illustrates a flowchart of an approach for implementing an image entry mode at a mobile device according to some embodiments of the invention.

FIGS. 20A-D illustrate an image entry mode at a mobile device according to some embodiments of the invention.

FIG. 21 illustrates a flowchart of an approach for stitching images together according to some embodiments of the invention.

FIG. 22 illustrates an example approach for implementing a mileage tracking entry mode at a mobile device according to some embodiments of the invention.

FIG. 23 illustrates a flowchart of an approach for implementing a mileage tracking entry mode at a mobile device according to some embodiments of the invention.

FIG. 24 depicts a computerized system on which embodiments of the invention may be implemented.

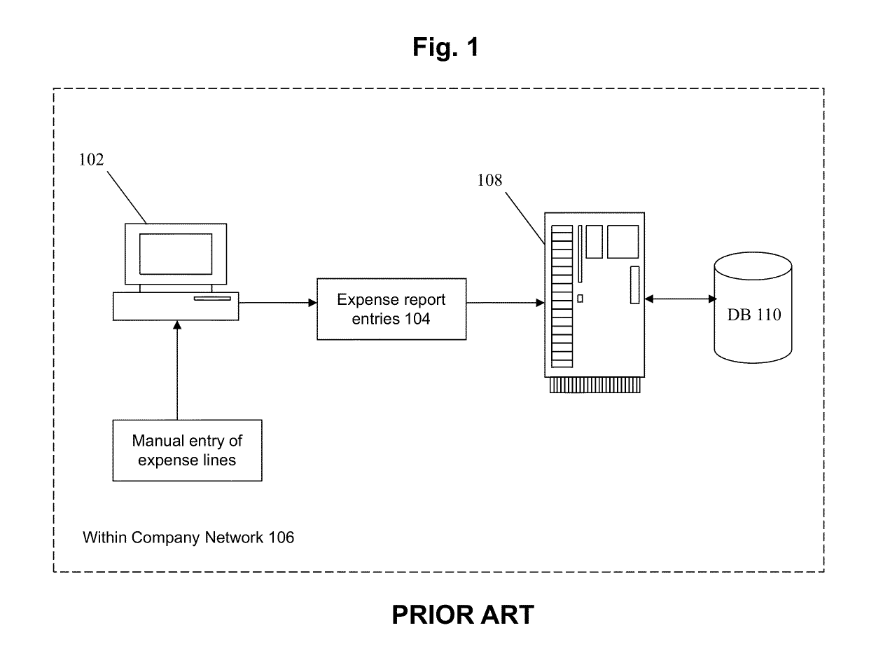

### DETAILED DESCRIPTION

Mobile devices such as smartphones have revolutionized the way in which employees work. More and more employees are able to perform key duties of their jobs using mobile devices. The present disclosure provides an improved method, system, and computer program product for implementing expense entries by using mobile devices. According to some embodiments of the invention, mobile devices are integrated into the expense solutions architecture such that expense-related data can be captured, created, entered, and/or edited on the mobile device. This disclosure describes the design of the mobile application approach that allows users to create expenses on a mobile device using various input methods such as quick entry, receipt imaging, voice capture, and manual entry and the subsequent upload of these expenses to the enterprise applications.

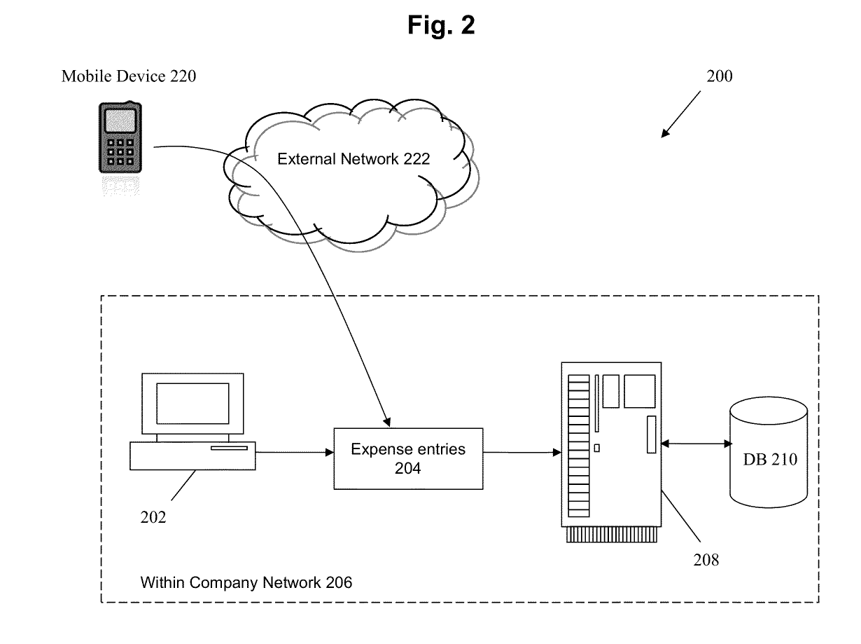

FIG. 2 illustrates a high-level diagram of this approach of integrating mobile devices 220 into the expense solutions architecture 200. Unlike prior approaches, the mobile device 220 can be used to create and edit expense entries 204 (also referred to herein as “expense items”, “expense lines, or “expense line entries”) that are provided to an application server 208, which can then be saved into a database 210. In this approach, the mobile device 220 may be entirely outside the company network 206, but may communicate to the application server 208 through an external network 222, such as a cellular network connection or a WiFi network connection. The expense entries 204 can then be processed, e.g., at the workstation/computer 202 when the user returns to the office, to create expense reports for submission. Examples of mobile devices that may be utilized in this manner include mobile telephones, smartphones, tablet computers, PDAs, and any other suitable portable device.

One key advantage of this approach is that it allows the user to generate expense entries more in alignment with the location/way that many expense are actually generated, e.g., while the user is away from the office computer. Even while away from the office, the user will likely be with his/her mobile phone and it would be convenient for the user to be able to enter expense lines using the mobile device at, or very near, to the time/location at which the expense are actually being incurred, instead of waiting until the user returns back to the work computer to enter the expenses.

Another key advantage of this approach is that the mobile expense application on the mobile device can be configured to access tools and data on the mobile device to more efficiently perform entry of the expense entries. For example, a GPS mechanism within the mobile device can be used to identify the location of the mobile device, with this location information usable to auto-populate location-related fields in the expense entry that is being created or edited on the mobile device.

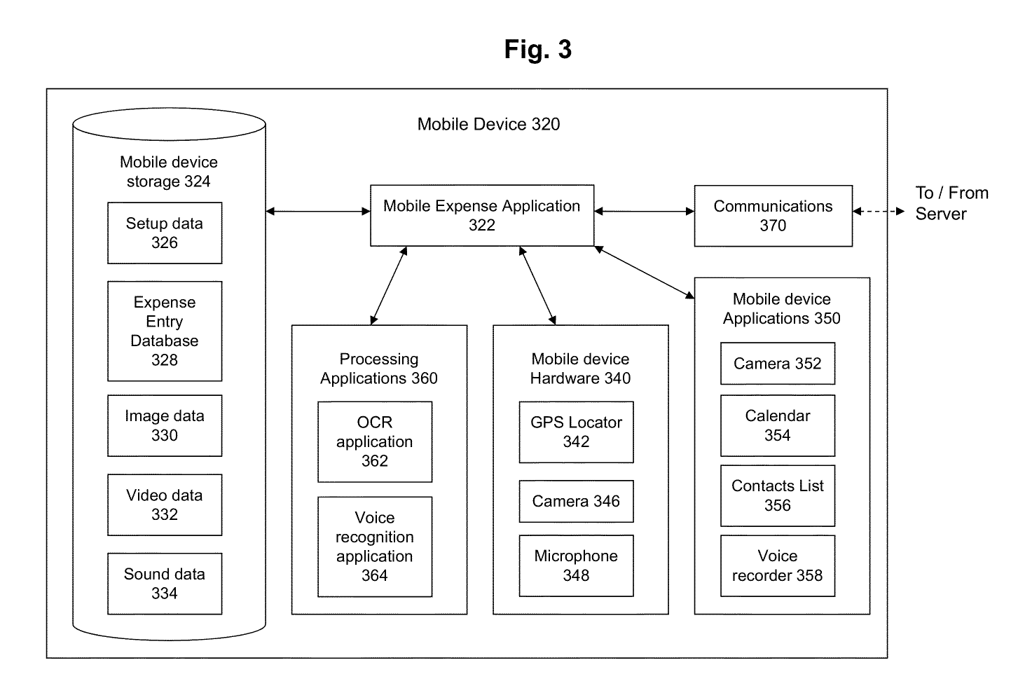

FIG. 3 illustrates an example architecture that may be used to implement a mobile device 320 according to some embodiments of the invention. Mobile device 320 includes a mobile expense application 322 that is operable to allow a user to utilize the mobile device 320 to perform the functions of creating and editing expense entries. The mobile expense application 322 may access one or more mobile storage device mechanisms 324. The mobile storage device mechanism 324 may be implemented as one or more computer readable mediums or storage devices that hold data within the mobile device 320. Mobile storage device mechanism 324 comprises any combination of hardware and software that allows for ready access to the data that is located at the mobile storage device mechanism 324. For example, mobile storage device mechanism 324 could be implemented as persistent and/or non-persistent storage operatively managed by an operating system on the mobile device 320, e.g., flash memory storage.

The mobile expense application 322 may access the mobile storage device mechanism 324 to perform the functions of creating and editing expense entries. Therefore, the mobile storage device mechanism 324 may be used to implement an expense entry database 328 that holds the expense entries that are created on the mobile device 320. In addition, the mobile storage device mechanism 324 may be used to hold any setup, configuration, or reference data 326 that is needed to initialize, configure, or operate the mobile expense application 322.

The mobile expense application 322 can be configured to access any type of data that may be stored on the mobile device 320 that is of interest to expense reports, such as image data 330, video data 332, and sound data 334. As described in more detail below, these data items may be accessed to generate content that may be used to auto-populate certain fields within an expense entry. The image data 330, video data 332, and sound data 334 may be stored to, and accessed from, the mobile storage device mechanism 324.

In some embodiments, the mobile expense application 322 may access hardware devices 340 on the mobile device 320. For example, the mobile expense application 322 may utilize a GPS locator device 342, camera 346, and/or sound capture device 348 (e.g., microphone) on the mobile device 320.

Furthermore, the mobile expense application 322 may access software applications 350 that are located on the mobile device to obtain or generate information of interest to expense reports. For example, the mobile expense application 322 may utilize a camera application 352, calendar application 354, contact list application 356, and/or voice recorder application 358 to generate or edit expense entries to be stored in expense entry database 328.

Processing applications 360 may be located onto the mobile device 320 to assist the operations of the mobile expense application 322. For example, an OCR (optical character recognition) application 362 may be operationally accessed by the mobile expense application 322, e.g., to perform OCR functions on image data 330 that may include information of interest to expense entries (such as images of sales receipts). As another example, voice recognition application 364 may be operationally accessed by the expense application 322, e.g., to perform voice-to-text recognition functions on voice data 334 that may include information of interest to expense entries (such as voice recordings of expense items). It is noted that such processing application 360 do not necessarily need to be locally present onto the mobile device 320. Instead, some embodiments include these types of application on the server, where the image data 330 and/or voice data 334 are transmitted to the remote server to perform the OCR and voice recognition functions.

In some embodiments, it is contemplated that the users will be able to use the mobile application for expense capture even when the mobile device is in a disconnected mode (e.g., when the mobile device does not have a wireless connection or connection to their enterprise servers). In this situation, it may be desirable to have some of the processing applications 360 located on the mobile device. However, in disconnected mode, certain features of the mobile application will not be available to the user when there is no wireless connection or network connection (e.g., for processing applications that are actually located on the server). In addition, synchronization between the mobile device and the server may not be possible in disconnected mode.

The mobile device 320 may also include communications mechanism 370 to send and receive data between the mobile device 320 and the remote server. In some embodiments, the communications mechanism 370 operates to allow the mobile device 320 to communicate using a cellular network connection, e.g., when the mobile device 320 is a mobile telephone. The communications mechanism 370 may also be implemented to allow the mobile device 320 to communicate using other networking paradigms, e.g., to communicate over a WiFi network.

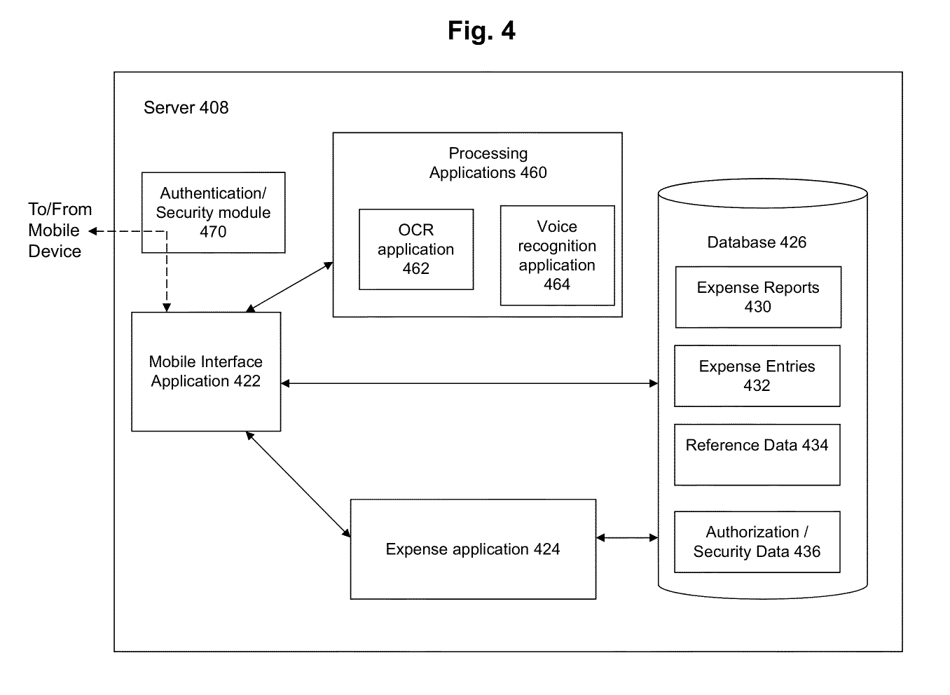

FIG. 4 illustrates an example architecture that may be used to implement a server 408 according to some embodiments of the invention. Server 408 includes a mobile interface application 422 that is operable to integrate the data sent from the mobile device to an expense application 424 at the server 408. The mobile interface application 422 contains functionality to communicate with the mobile device to perform intake of expense entries, and to send response and/or setup data to the mobile device. The expense application 424 corresponds to any suitable financial application that can be used to manage and create expense reports. For example, the Oracle Fusion Expenses product, part of the Oracle Fusion Financials Suite, available from Oracle Corporation of Redwood Shores, Calif., is a suitable product that can be used to implement the expense application 424.

The server 408 may include or is associated with one or more databases 426. The database 426 holds data that is utilized by the mobile interface application and/or expense application 424. For example, the database 426 may be used to hold expense entries 432 that are generated by a user, which are created either at a mobile device or at a local workstation/computer. The database 426 may also hold expense reports 430 that are created and populated using the expense entries 432. In addition, the database 426 may contain setup/reference data 434 that is needed by the expense application 424, mobile interface application 422, and/or the mobile device to process the expense entries. The database 426 may also be used to store authentication/authorization/security data 436 for users of the system.

Processing applications 460 may be located on the server 408. These processing applications 460 may be implemented to assist the operations of the mobile expense application on the mobile device or the expense application 424 on the server 408 to enter or edit expense entries. For example, an OCR (optical character recognition) application 462 may be operationally accessed to perform OCR functions on image data that is received from the mobile device. Similarly, voice recognition application 464 may be operationally accessed to perform voice recognition functions on voice data that is received from the mobile device. Processing applications 460 do not necessarily need to be loaded onto the server 408. Instead, some embodiments include these types of application on the mobile device.

Server 408 also includes an authentication/security module 470 to manage access to the server 408 and/or the expense application 424 from users at the mobile devices. The authentication/security module 470 handles authentication and authorization management tasks for user access to the server from mobile devices. In some embodiments, to use the expenses mobile application, the user must be an employee and the user must be set up in the server expense application. The user should have a valid authorization (e.g., authorization to perform expense entry duties) assigned to the user to use the mobile application. In addition, for the user to enter projects and tasks the user must have appropriate authorization (e.g., authorization to perform project expense allocation duties) to enter the projects and tasks. Appropriate authorization (e.g., authorization to perform expense account allocation duties) should exist for the user to charge to cost centers and companies.

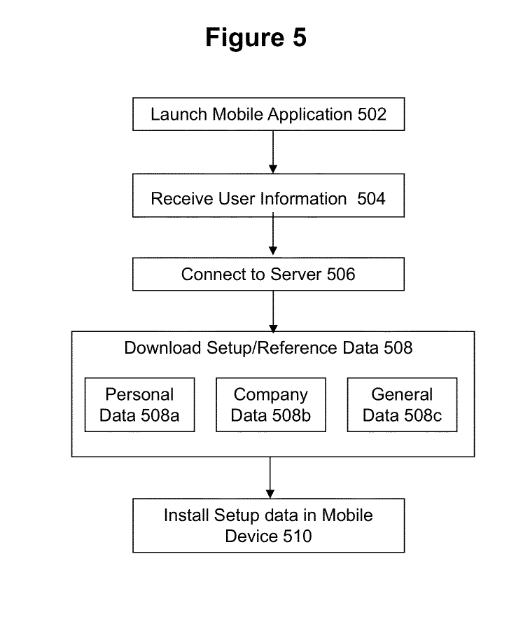

FIG. 5 shows a flowchart of an approach for performing first time setup of the mobile expense application on the mobile device. At 502, the mobile application is launched at mobile device, e.g., by navigating to the mobile expense application on the mobile device. This may be implemented by clicking on an icon for the mobile application on the user interface of the mobile device.

At 504, the mobile application will receive information from the user that is used to initiate/start the application. For example, when the user attempts to log in for the first time, the user will be directed to a “settings” interface to require entry of certain information by the user. The user may be asked to enter a user identifier (e.g., name), authentication token (e.g., password), and remote connection request (e.g., a server ID or host URL). The mobile application will connect to the server at 506, and will attempt to authenticate the user using the user information that was received.

On successful login, the application will download a number of reference/setup data at 508. The setup/reference data includes, for example, personal information 508a for the user, company-specific data 508b, and/or general reference data 508c. Personal data 508a includes, for example, information that directly corresponds to the specific user on that mobile device. Company specific information 508b includes, for example, data pertaining to or set forth by the organization that employs the user. General reference data 508c relates to reference information of a general nature that may be used by the mobile expense application. The reference data is installed in the mobile device at 510.

After the first login, whenever the user invokes the mobile application, the user will be navigated to the main interface screen to perform the mobile expense functions. In some embodiments, new reference data may be downloaded or synchronized at that time. If the user accesses the mobile application in a disconnected mode (e.g., without a wireless connection or a VPN/Network connection), the mobile application will not sync any reference data. However, the application will later need to connect to a suitable network in order to upload any expense data to the server.

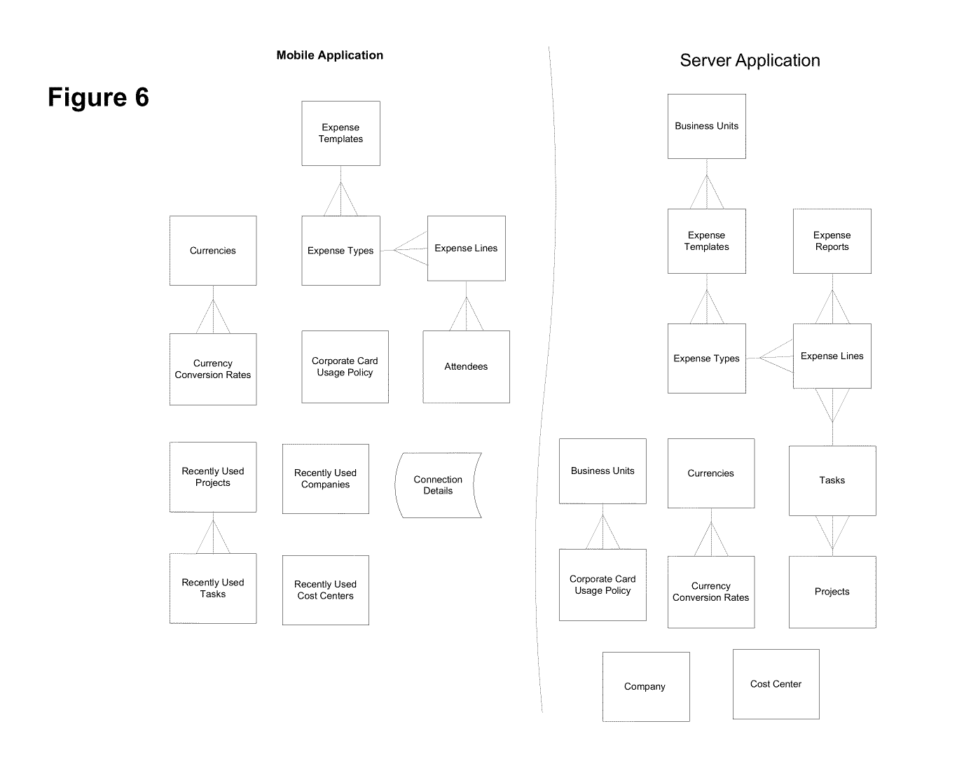

FIG. 6 illustrates example types of reference information that may be exchanged between the server and the mobile device. Active expense templates and expense types defined for the user's business units may be downloaded to the mobile device. In addition, data about currencies available in the enterprise application may be obtained. Data may be retrieved for currency conversion between U.S. dollars (USD) and other currencies. Corporate card usage policies, if existing, may be obtained. Reference data relating to receipt required policies by expense types may be retrieved. Also, the reference data may identify whether expense types are project enabled. “Favorites” (e.g., projects and tasks recently used by the user) may be identified.

The “Business Units” reference data pertains to a unit of an enterprise that performs one or many business functions and a unit of an enterprise that can be consolidated in both a managerial and legal hierarchy. The “Expense Templates” reference data pertains to a group of expense types used for a specific purpose. For example, an expense template for a Travel expense may consists of only expense types that can be used for travel purposes. These may be defined by business unit. The “Expense Types” reference data pertains to a type of expense that can be incurred by a user, e.g. Hotel, Airfare, Car Rental, Gift, Client Entertainment, or Employee Entertainment types. The “Expense Lines” reference data pertains to a business expense incurred by a user, e.g. for a stay at a hotel on a business trip, or a rental of a car on a business trip. These include data such as amount, merchant, date, and other information. The “Attendees” reference data pertains to attendees of an event for which the user incurred the expense. The “Expense Reports” reference data pertains to a document that lists the expenses incurred by an employee, which is used to obtain reimbursement of the expenses. The “Corporate Card Usage Policy” reference data pertains to corporate card policies established by the company that govern the business expenses incurred by an employee. For example, a policy may be implemented whereby employees must use their corporate card for all expenses exceeding 10 dollars. The “Currencies” reference data pertains to currencies available for use in expense reporting. The “Currency Conversion Rates” reference data pertains to conversion rates from one currency to another. The “Projects” reference data pertains to a project that represents the effort and resources required to achieve a significant business objective within a specific, usually finite, time frame. Projects are often used to plan, track, manage and control the both the financial aspects and the work effort requirement. The “Tasks” reference data pertains to units for breakdown of a project. The “Recently Used Projects” reference data pertains to the projects that relate to recently charged expenses. The “Recently Used Tasks” reference data pertains to the tasks that relate to recently charged expenses. The “Company” refers to companies that are vehicles for ownership, tax management, and legal compliance, and have reporting obligations. The “Cost Center” is a division that adds to the cost of a company. The “Recently Used Companies” reference data pertains to the companies that have recently charged expenses. The “Recently Used Cost Centers” reference data pertains to cost centers that have recently charged expenses. The “Connection Details” reference data pertains to details to connect to the enterprise application, such as login and host URL information.

Synchronization may occur if the user has appropriate authorization (e.g., appropriate project expense allocation or entry duty authorization). For this action in some embodiments, the relevant type of synchronization is for projects and tasks.

According to some embodiments, synchronization will perform the following actions: (a) download any changes to expense templates and associated expense types; (b) synchronize currencies available in the enterprise application; (c) synchronize currency conversion between USD and all other currencies; (d) synchronize corporate card usage policies if it exists; (e) synchronize receipt required policies by expense types; (f) synchronize information about whether expense types are project enabled; and (g) synchronize projects and tasks recently used by the user.

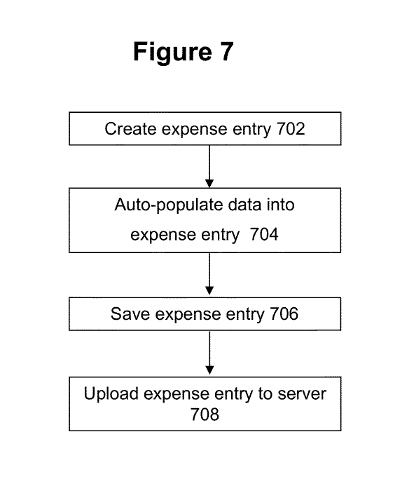

FIG. 7 shows a flowchart of an approach to generate expense entries on a mobile device according to some embodiments of the invention. At 702, the user creates an expense line entry on the mobile device using the mobile application. This is the key idea behind this embodiment of the invention, in which the expense entry can be created by the user using the mobile device out in the field, instead of requiring the user to wait until he/she is physically at a workstation within the company network. This means that the user can create the expense entry immediately, at or near the moment the expense is incurred (both in terms of time and location).

In addition, the user does not necessarily need to enter each and every field that is required for the expense line entry. Instead, at 704, built-in mechanisms and/or applications within the mobile device may be used to auto-populate one or more fields within the expense line entry.

For example, many expense application systems and/or company policies have a required field in expense entries to identify the “location” at which an expense was incurred. Instead of requiring the user to manually enter the location into the designated location-related field(s) of the expense entry, the mobile device can identify the location using a built-in GPS mechanism. The location information that is obtained from the GPS mechanism can then be used to auto-populate the location fields of the expense entry.

Once the expense entry has been created, at 706, the user may save the expense entry into the local database on the mobile device. In some embodiments, a validation action may be performed at the mobile device. This is to address the situation in which the expense entry violates a policy for expense entries, e.g., a violation of company expense policies. Thereafter, at 708, the expense entries locally stored at the mobile device may be uploaded to the remote application server.

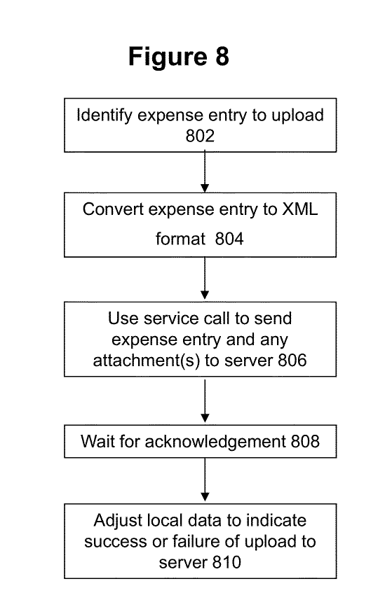

FIG. 8 shows a flowchart of an approach for uploading expense entries from the mobile device to the application server according to some embodiments of the invention. At 802, one or more expense entries are identified to be uploaded to the server. In some embodiments, the user specifically identifies the entries at the mobile device that are ready to be uploaded. In an alternate embodiment, expense entries are automatically uploaded upon synchronization between the mobile device and the application server.

At 804, the expense entry is converted into suitable format for transmission to the server. For example, in some embodiments, the expense entry is converted into XML prior to transmission to the server, although other formats may also be employed in other embodiments of the invention.

At 806, a service call is made to send the expense entry to the server. The service call performs the necessary communications functions to transmit the expense entry data across the network to the server. In some cases, there may be one or more attachments that need to be transmitted along with the expense entry. For example, the user may have taken a picture of a receipt, and associated the image file for the picture with the expense entry. If this is the case, then the image file of the receipt is also attached to the expense entry for transmission to the server.

The mobile device will then wait for an acknowledgement from the server. This is because the server may be configured to perform a validation check for the expense entry data that was transmitted to the server. Therefore, at 808, the mobile device will await the results of the validation check. According to some embodiments, it is contemplated that the user may create expense entries that violate certain company policies. In this situation, the mobile application may capture justification information from the user for policy violations when the user creates expenses that violate the company policies, e.g., when the user is entering expenses based on company policies.

At 810, the mobile device will adjust the status of the expense entry data in its local storage based at least in part on the results of the server's validation check. The expense entry data may have been either successfully uploaded or unsuccessfully uploaded. An indication can be made at the mobile device to show the status of the upload for the expense entry. For example, color-coding can be used to show the status of the expense line entry, e.g., highlighting the entry in the mobile device interface with a green color if successfully uploaded or a red color if unsuccessful.

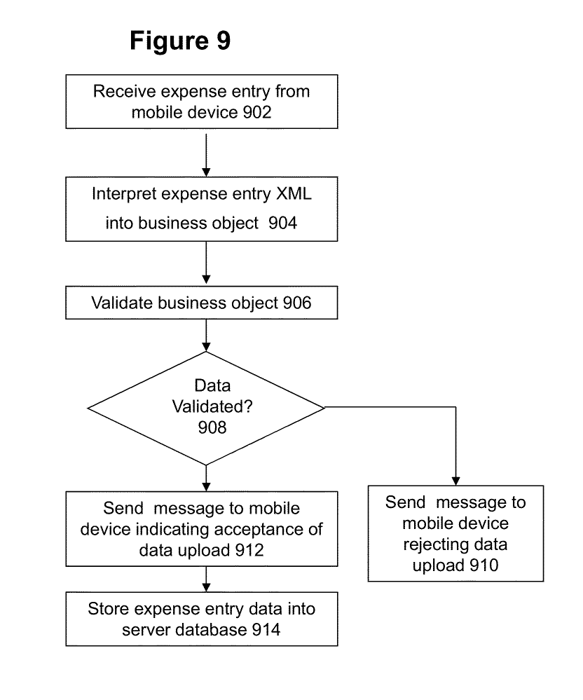

FIG. 9 shows a flowchart of actions taken at the server to process the expense entries received from the mobile device. At 902, the expense entry data is received from the mobile device. In some embodiments, the expense entry data includes the XML formatted expense lines from the mobile device, but it is noted that the expense entry data may also be in other formats as well. In addition, the expense entry data may also include any attachments that are associated with the expense lines from the mobile device.

At 904, the format of the expense entry data (e.g., XML format) is interpreted and converted into any format or information type/content that is usable within a financial application to process the expense entry data. For example, in some embodiments the expense entry data is converted into a business object that includes information pertaining to the business of the enterprise that can be recognized by the expense application at the server. In addition, authentication information may be sent with the XML request. Any suitable approach can be used to compose the expense entry data into the correct format for the expense application.

At 906, validation is performed on the expense entry business object. For example, there may be company policies relating to content or format requirements for the expense entries that need to be checked before the entries can be accepted. This check is made to see if the user had correctly entered the required information in the correct format. This type of validation may be performed at the mobile device in addition to the server, solely at the mobile device, or solely at the server. In addition, this check will also identify whether the data may have been corrupted during the upload process.

At 908, a determination is made whether or not the expense entry is acceptable. If not, then at 910, a message is sent to the mobile device rejecting the data upload. If, however, the uploaded data is acceptable, then at 912 a message is sent to the mobile device indicating acceptance of the uploaded entry. At 914, the acceptable entries are stored into the database at the server. Any attachments associated with the acceptable expense entry may also be stored in the server database.

Once those entries are stored in the server, the user can then access those entries at a later date for any number of purposes. For example, the user may access those entries to perform additional modifications or editing on those entries, e.g., once the user returns to the office and seeks to access those entries from a workstation. In addition, the user may access those entries in the server database to populate an expense report that is submitted for payment.

Embodiments of the invention therefore provide a much more efficient entry approach to allow a user to create and enter expense line entries, by using a mobile device that is integrated with the enterprise expense application.

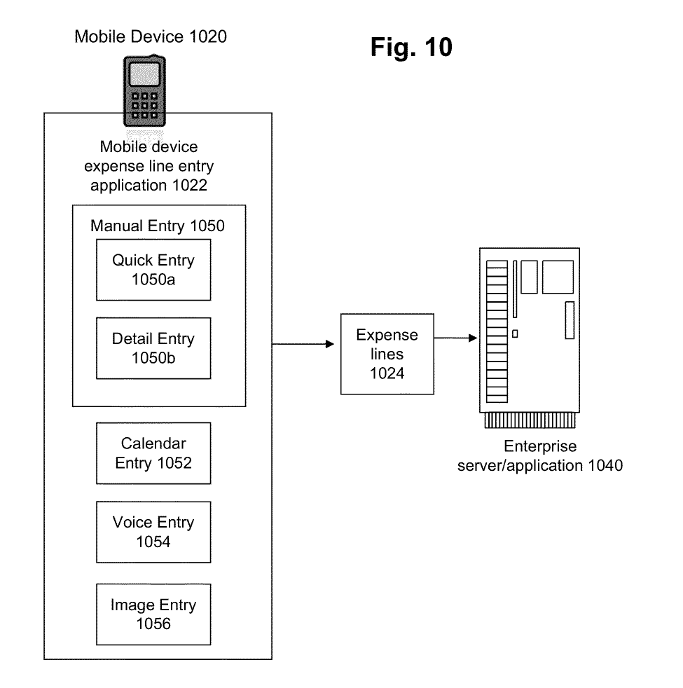

FIG. 10 illustrates a diagram of possible expense line entry modes according to some embodiments of the present invention. This figure shows that the mobile expense application 1022 on the mobile device 1020 may utilize various approaches to capture information that pertains to new expense line entries 1024, which may be used to create and populate the expense line entries 1024 more efficiently such that the user is relieved from having to manually enter all of the necessary information on the mobile device 1020 before transmission to the server 1040.

For example, the user may use a (a) manual entry approach 1050, (b) calendar entry approach 1052, (c) voice entry approach 1054, or (d) image entry approach 1056 to create and populate expense line entries 1024. Each of these approaches is described in more detail below.

The manual entry approach 1050 refers to an approach that allows users to manually create expense items. A quick entry approach 1050a allows the user to quickly utilize an interface on the mobile device to create an expense line entry, where some of the information items for the entry is auto-populated from the mobile device rather than from the user. For example this approach allows the user to select the expense type and enters the amount. Data that may be auto-populated include “Date” information that corresponds to the mobile device current date, “Location” information that is derived from the GPS location, and “Currency” information that is derived from the type of currency used at the location of the mobile device. The detailed entry approach 1050b is where user manually enters many or all of the details of the expense entry. Some information that may be manually entered in this approach includes one or more of the following: Expense type, amount, description, project, task, company, cost center, attendees, justification when required, and documents to attach.

The calendar entry approach 1052 allows users to use a calendar event to create an expense. From the calendar event, the mobile application automatically creates the expense with certain expense entry data auto-populated from the calendar information, e.g., the event location, event date, and event attendees as expense information.

The voice entry approach 1054 allows users to create a recording of the expense information and then extract the expense information from the voice recording to automatically create an expense item. In some embodiments, the voice recording can be attached to the expense item, and users are able to edit the line and change the expense information later. A voice-to-text conversion tool maybe employed to convert the voice data to text.

The image entry approach 1056 allows users to take a picture of a receipt and then extract the expense information from the receipt image using OCR technology to automatically create an expense item. In some embodiments, the image data can be attached to the expense item, and users are able to edit the line and change the expense information later.

In any of these entry modes, one key advantage provided by embodiments of the invention is that the mobile application can auto-populate certain fields of the expense entry using the mobile device. As such, user can create expenses very quickly using only a minimal amount of information (e.g., expense type and expense amount), and then leveraging the functions available on the mobile device to auto-populate the other fields of the expense data. For example, the mobile expense application can default the value of the location field in the expense entry based on the mobile device location, or utilize location data that is available from the expense source such as the location on the receipt image. As another example, the currency type can be derived based on the location of the mobile device.

In some embodiments, the mobile expense application will be downloaded from an application store of the phone provider and accessed through the icon downloaded for the application on the phone. When the user clicks on the expense application icon, the user will be taken to a screen with a number of icons representing the various tasks available in the application. This main screen is referred to herein as the “Springboard.”

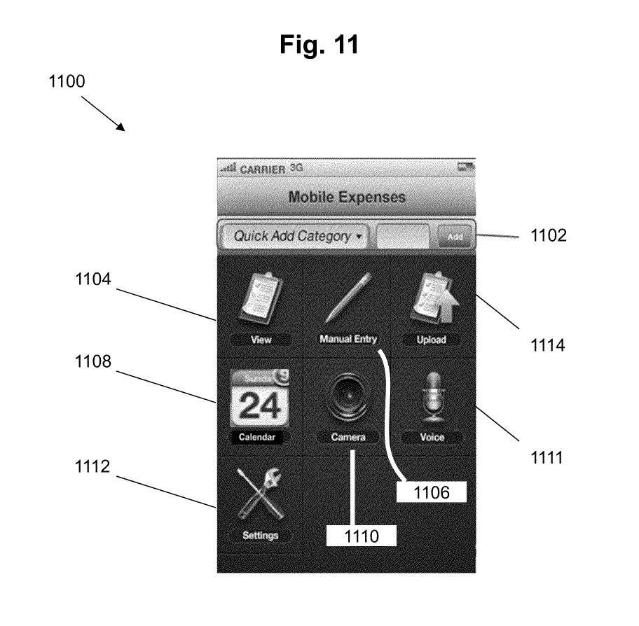

As shown in the example interface 1100 of FIG. 11, the springboard will contain interface elements to perform the different entry methods identified above. For example, interface element 1102 provides a button element and text field for performing a quick entry of an expense item. Icon-based interface elements may also exist in interface 1100 to implement the other entry modalities. For example, the view icon element 1104 allows users to navigate to a screen to view expenses. The manual entry icon element 1106 permits users to navigate to a screen to add expenses manually. The upload icon element 1114 permits users to navigate to a screen to select expenses and upload to enterprise application server. The calendar element 1108 navigates the user to a screen from which the user can select the event and let the application create an expense from the event details. The camera element 1110 enables the camera so that the user can take a picture and to utilize the mobile expense application to create an expense from the image (e.g, of a receipt). The voice element 1111 enables the microphone so that the user can voice record the expense details and utilize the mobile expense application to create an expense from the voice recording. The settings element 1112 navigates the user to a screen where users can enter and set login details and other preferences. When the user accesses the mobile expense application for the first time, the user may be brought to a login screen instead of the springboard screen to capture certain login/setup information, e.g., the username, password, and the connection URL. The user may then be navigated to the springboard interface 1100 after the first login.

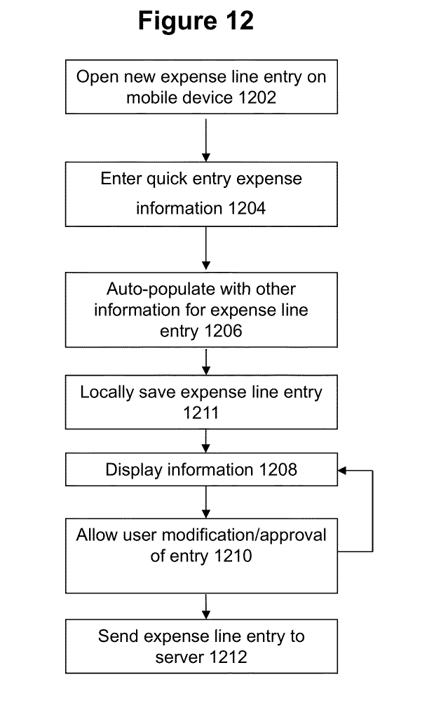

FIG. 12 shows a flowchart of an example approach for implementing a quick entry approach for generating expense entries. With the quick entry approach, only a minimal set of information needs to be entered by the user. For example, in some embodiments, the user only needs to enter the “expense type” and the “expense amount” for a quick entry.

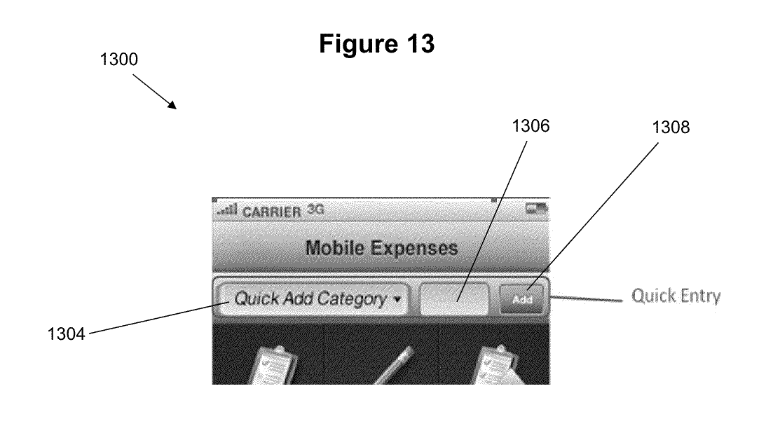

At 1202, the new expense line entry is opened on the mobile device. At 1204, necessary expense information is entered into the mobile expense application. For example, information about the expense type and the expense amount maybe entered at 1204. FIG. 13 shows an example interface 1300 that may be used to create and enter expense entries using the quick entry approach. A scrolling or spinning text interface 1304 may be provided to allow the user to scroll to an appropriate entry type. The scrolling menu structure may include a number of expense types (such as “meal expense”, “taxi expense”, etc.), and the user scrolls through the list until the correct expense type is found and selected. A number entry field 1306 may be used to enter the amount of the expense. Button element 1308 may be used to generate the entry once the required information has been provided.

Returning back to FIG. 12, at 1206, other items of information may be auto-populated into the expense line entry. For example, the mobile device may include a GPS mechanism that allows for a location to be determined for the mobile device. The “location” field of the expense line entry may thus be auto-populated from this GPS-determined location. Similarly, the currency type may be auto-determined from the location (e.g., if the location is in the US, the currency type can be auto-determined to be in dollars). This type of auto-population of data fields may be performed “behind the scenes”, without requiring the user to manually input this data.

At 1211, the new entry may be saved into local storage at the mobile device. Thereafter, the user may use an appropriate interface to view and/or edit the entry. If so, then at 1208, the information for the expense entry is displayed to the user. The user may, at 1210, either approve the entry or perform some type of correction to the entry. At 1212, the expense line entry is submitted to the server.

This disclosure will now describe how to implement the voice entry of expense items according to some embodiments of the invention. The voice entry approach refers to an approach that allows the user to use voice commands to create an expense line entry.

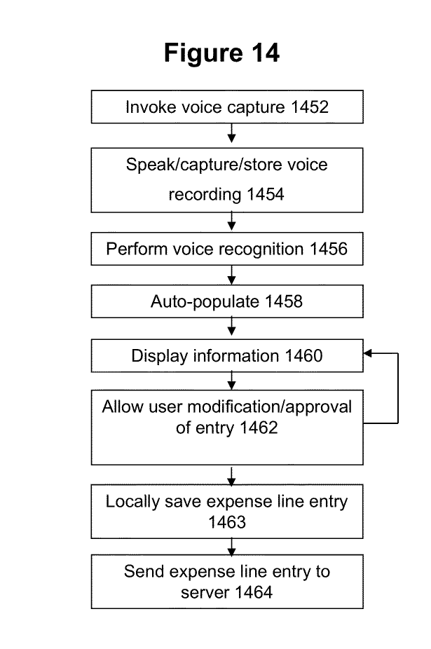

FIG. 14 shows a flowchart of an example procedure for implementing the voice entry approach. At 1452, the user invokes voice capture mode to enter a new expense line entry on the mobile device, e.g., by selecting an interface element on the mobile device corresponding to the voice entry mode. At 1454, the user speaks into the mobile device where a voice capture mechanism (e.g., a microphone) will capture sound data associated with the voice entry. In some embodiments, the sound data is stored into local storage on the mobile device. In alternate embodiments, the sound data comprises a stream of voice data that is processed as a stream by downstream applications (e.g., voice recognition applications as described below).

A designated set of data should be provided by the user in voice form. For example, like the quick entry mode described above, the mobile application may be configured to require the user to provide the expense type and an expense amount. However, this aspect of requirements for specified fields may be configurable depending upon the specific application to which the invention is directed.

Next, at 1456, voice recognition will be performed on the voice entry. Any suitable speech-to-text conversion application may be employed to perform voice recognition. In some embodiments, the speech to text conversion application is located on the server, and therefore the voice stream is passed to the server, with a set of recognized text returned back from the server to the mobile device. In an alternate embodiment, the speech to text conversion application is located on the mobile device to locally perform the voice recognition functionality on the mobile device.

In any case, the voice recognition operation will be performed to check for recognizable voice commands relating to creating and populating the expense line entry. For example, an attempt will be made to recognize numerical content in the voice stream to be identified as the expense amount. Similarly, an attempt will be made to recognize the word-based content in the voice stream as the expense type, and to correlate the word-based content to specific expense types. For example, a voice entry that includes the voice recognized text of “Meals 20” would have the word-based “meals” portion correlated to the expense type field and the number-based “20” portion correlated to the expense amount field. Synonym functionality may be employed for the voice recognition to relate different words together. For example, words such as “lunch”, “dinner”, “meals” may all be correlated to the same expense type of “meals”. It is noted that additional types of information and/or functions may be captured/implemented using voice entry in some embodiments. For example, additional information pertaining to Vendors may be captured using voice entry.

At 1458, other items of information may be auto-populated into the expense line entry. For example, similar to the quick entry, the mobile device may use a built-in GPS mechanism that allows for a location to be determined for the mobile device, and to auto-populate the “location” field of the expense line entry with the location information. In addition, the currency type may be inferred from the location of the mobile device.

At 1460, the information for the expense line entry is displayed to the user. The user may, at 1462, either approve the entry or perform some type of correction to the entry. At 1463, the new entry is locally saved at the mobile device. Thereafter, at 1464, the expense line entry can be submitted to the server.

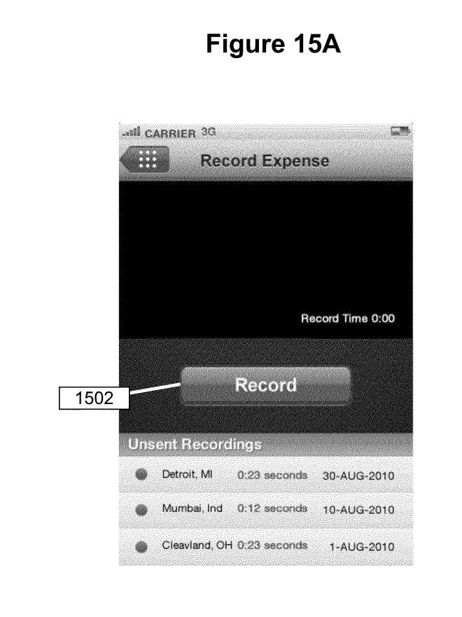

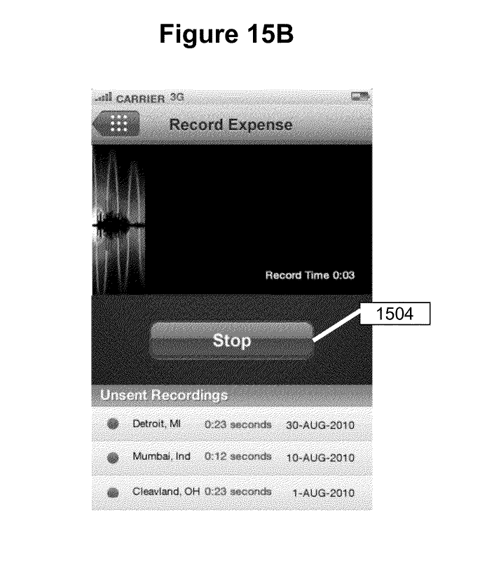

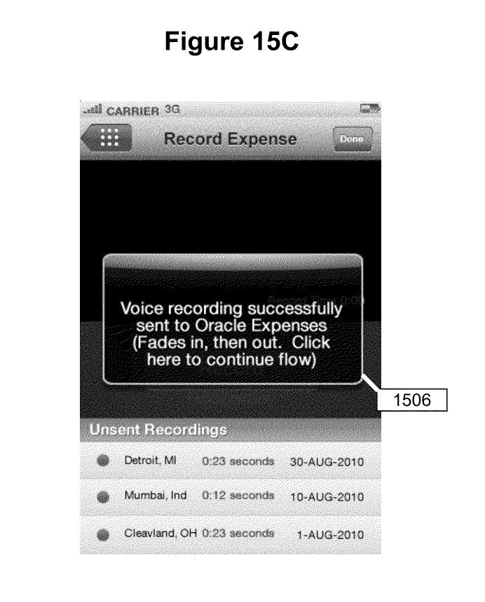

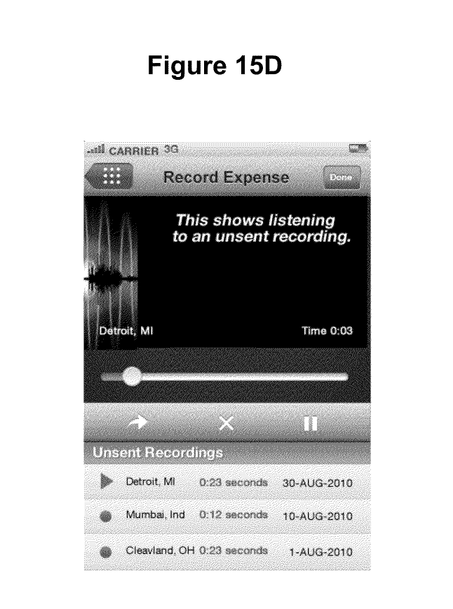

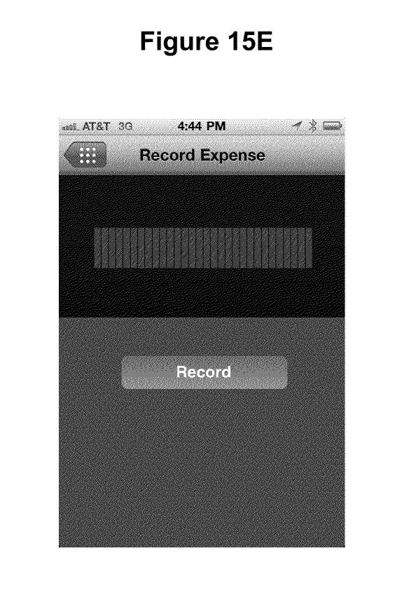

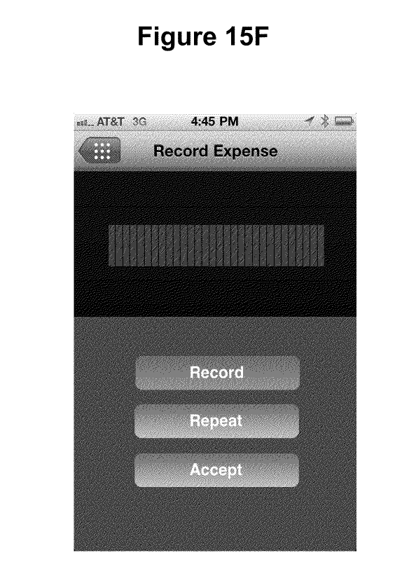

FIGS. 15A-D illustrate example interfaces that may be employed to perform voice entry of expense items. With this interface, icons in the springboard interface navigate the user to a recording mode, where the screen will display “Record” button 1502 as shown in FIG. 15A. When the user clicks on the Record button 1502, then the application will start recording the voice into a sound file or voice stream dataset.

In some embodiments, the expense type recorded should be in the format of <expense type> <amount>, e.g., “taxi 10”. When the recording is in progress, the screen will display Stop button 1504 as shown in FIG. 15B. Clicking on stop button 1504 will stop the recording. As shown in FIG. 15C, a status message 1506 will be displayed to the user, e.g., describing whether or not the recording was successful. At that point, the user may be presented with certain option to either record a new voice entry or to replay the recording (e.g., as shown in FIG. 15D).

The above-described sequence relates to an approach in which the user performs the recording function, and then selects one or more recording to be created as the entry item. In this flow, there is no requirement to perform an “accept” function. The recording is sent for expense creation, and then the user will review to see if the item details are correct.

In an alternate approach, recording is performed, and the mobile application will replay the recording, while giving an option to accept the recording, e.g., if the recording can be recognized by the mobile application/device. In this approach, the user is given the option to accept the recording, upon which the mobile application will create an expense item. This approach is illustrated in FIGS. 15 E-F, in which FIG. 15 E shows an example interface for performing the recording functionality. FIG. 15F shows an example interface for providing an option to accept the recording, from which the mobile application creates an expense item.

In this approach, the user is presented with the option to accept the voice recording, which in some embodiments is displayed only if the recording quality is acceptable. When the user clicks Accept, the mobile application will use a voice to text engine to convert the recording into text. The application will pattern match the text to derive the expense type and the amount. The application will create a new expense line. The user can edit the line to change any details. When the user clicks the “Save” button, the new line will be saved to the mobile database.

This disclosure will now describe how to implement the calendar entry approach for generating expense items according to some embodiments of the invention. The calendar entry approach refers to an approach that allows the user to use calendar entries from a calendar application on the mobile device to create and populate an expense line entry. There are multiple ways that calendar entries can be used to populate an expense item. One approach is to use the calendar entry to generate a new expense item that will be auto-populated from the calendar entry. Another approach is to associate a calendar entry with an existing expense item, so that the data within the calendar entry is used to supplement the content of the expense item.

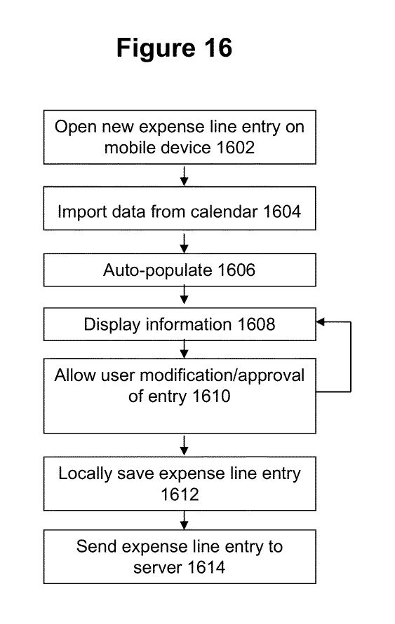

FIG. 16 shows a flowchart of an example procedure for implementing the calendar entry approach, where the calendar entry is used to generate a new expense entry. At 1602, the new expense line entry is opened on the mobile device, e.g., based on the user identifying a calendar entry that pertains to a new expense line entry.

At 1604, data from a calendar entry identified by the user is imported into the expense line entry. Such data may include, for example, the date, event name, attendee list, and location data for the calendar data. Next, at 1606, other items of information may be auto-populated into the expense line entry. For example, if the location data is not imported from the calendar data, then this field can be auto-populated using the built-in GPS mechanism on the mobile device.

At 1608, the information for the expense line entry is displayed to the user. The user may, at 1610, either approve the entry or perform some type of correction to the entry. At 1612, the entry is locally saved at the mobile device. Thereafter, at 1614, the expense line entry is submitted to the server.

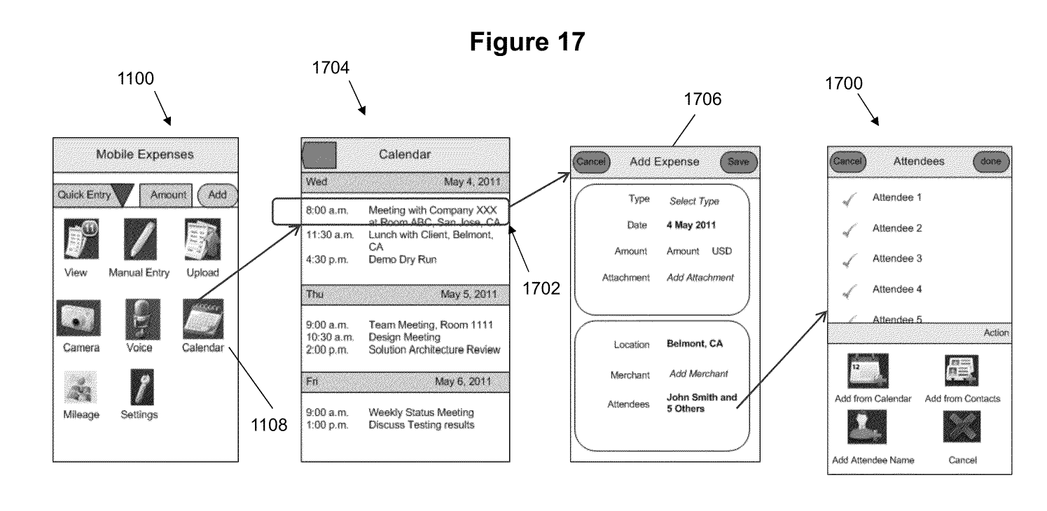

As shown in FIG. 17, a calendar icon 1108 in a Springboard 1100 may be used by a user to initiate calendar entry mode. This brings the user to a calendar interface 1704, from which the user can select an event (e.g., calendar entry 1702). It is noted that the underlying calendar application may be located on either the mobile device or the server. Upon selection of the calendar entry 1702, the mobile application will automatically create an expense item 1706.

Details from the calendar entry 1702 may be used to auto-populate the expense item 1706. Information such as such as attendees, location, and date may be auto-populated into the expense item 1706 from the calendar entry 1702. As shown in Attendee interface 1700, attendee information maybe auto-populated from the calendar entry 1702. In addition, the entry information may also be added from other applications as well. For example, interface 1700 permits attendee information to be added from a Contacts application in addition to a Calendar application. Other items and types of data for the expense item 1706 may also be auto-populated from other mechanisms within the mobile device. For example, the currency type may be auto-populated in the expense item 1706 based upon the mobile device location (or the value of the location field if different).

This disclosure will now describe how to implement the image capture approach for generating expense items according to some embodiments of the invention. To explain, consider how a typical expense system would require an employee to deal with receipts. The employee would have to save all receipts from the expense event, and to later manually enter the receipt information into the expense reporting system. The problem is that this is typically a highly manual process that is very time-consuming and is prone to mistakes. Moreover, the employee must be diligent about preserving the receipts, which may be quite difficult, e.g., when the employee is on a business trip and there is a very large number of receipts that the employee collects throughout the trip. Indeed, it is quite possible that employee may end up losing some of the receipts before he/she returns back to the office and has an opportunity to enter the receipts into the expense reporting system.

The present disclosure provides much more efficient entry approaches to allow an employee to create and enter expense entries from physical items such as receipts. In general, the employee can take a picture of the receipt and use the captured image to generate the expense line entry. For example, the employee may use the employee's mobile device (that includes an image capture mechanism) to take a picture of the receipt. The picture of the receipt is then used to populate the expense line entry.

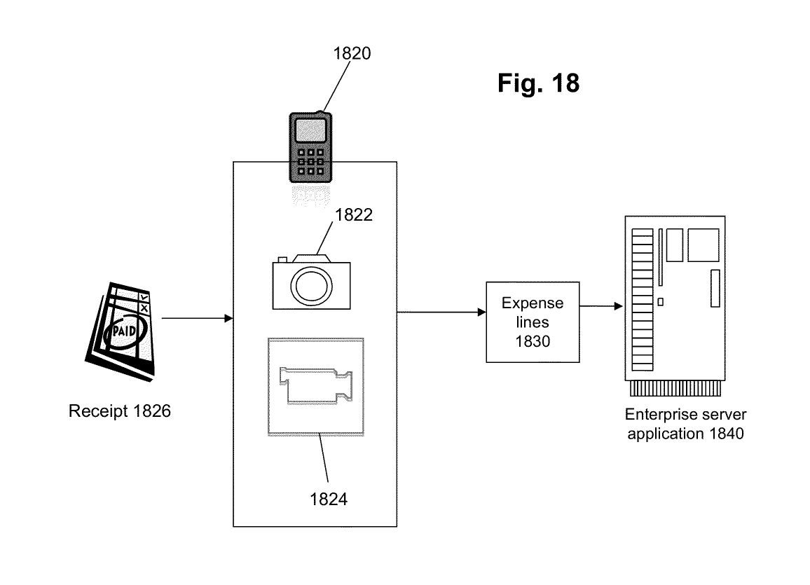

FIG. 18 illustrates a high-level diagram of the present invention. This figure shows that the mobile expense application on the mobile device 1820 may utilize either a camera mechanism 1822 or a video capture mechanism 1824 to capture an image of a receipt 1826. The image of the receipt 1826 is then used to populate an expense entry 1830 which is sent to an enterprise application server 1840 for processing. It is noted that the camera mechanism 1822 and/or the video capture mechanism 1824 may be physically located within the mobile device 1820. Alternatively, the camera mechanism 1822 and/or the video capture mechanism 1824 may be physically separate from the mobile device 1820, where image data captured by the camera mechanism 1822 and/or the video capture mechanism 1824 are copied or transmitted to the mobile device 1820.

In any case, by allowing the user to immediately take a picture of the receipt at or near the time of receiving the receipt, this allows the user to avoid the possibility of losing the receipt before entering the information into the expense line entry. In addition, this approach reduces the need for the user to manually enter certain types of information into the expense line entry, since the data from the receipt image can be used to auto-populate the expense line entry.

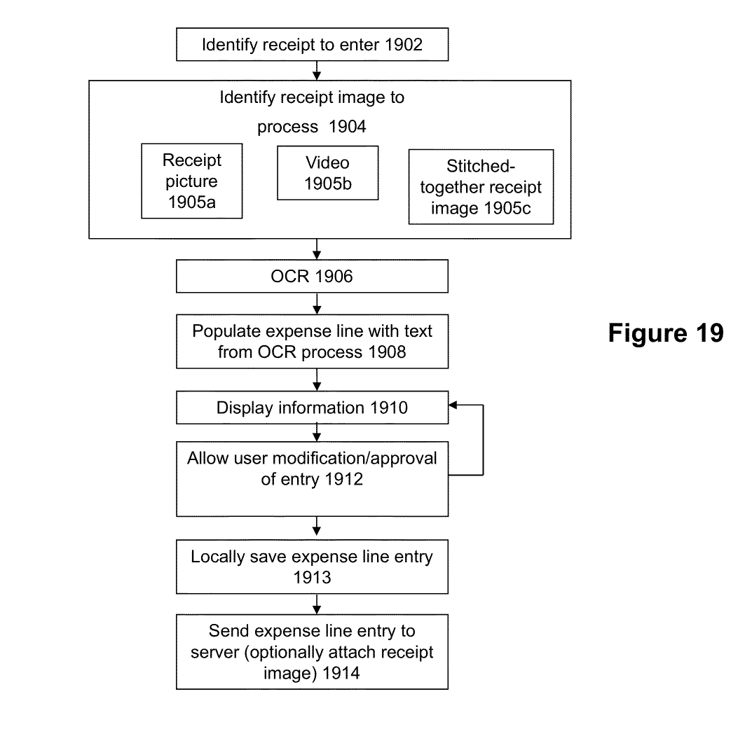

FIG. 19 shows a flowchart of an approach for implementing this embodiment of the invention. At 1902, the user identifies the receipt that is being used to enter the new expense line entry. At 1904, a determination is made of the receipt image that is to be used for processing. There are different types of images that may be employed to implement embodiments of the invention.

In one approach, a simple camera-based image 1905a of the receipt is used for processing. In this approach, the receipt is small enough in size such that the entirety of the receipt can be captured using a single camera image.

Alternatively, the user may wish to use a video capture mechanism to take a video 1905b of the receipt. This approach may be taken, for example, if the receipt is too large to be effectively imaged using a single camera picture and/or if the receipt is on multiple pages. As described in more detail below, the multiple image frames of the video would be processed to create a stitched-together image for processing under this circumstance.

The user may also take multiple still pictures 1905c of the receipt, which is used to create a stitched-together picture for the expense line entry. As with the video approach, this approach may be taken if the receipt is too large to be effectively imaged using a single camera picture and/or if the receipt is on multiple pages.

Next, optical character recognition is performed on the image file, at 1906, to recognize certain content from the receipt. The expense line entry is populated, at 1908, using the data from the OCR process. Keywords can be used to identify relevant portions of the receipt. For example, the receipt may include a section with a total dollar amount. The expense application could scrape the OCR data from the receipt image to look for the keyword “Total”, and use the numerical amount next to that keyword to populate the expense amount field of the expense line entry.

In particular, with regards to the OCR process, the mobile application will first reduce and clean the image to pass it to an OCR engine. The OCR engine will then convert the image to text file. The mobile application uses pattern matching to extract certain fields from the recognized text. For example, the receipt amount, date, location, and/or merchant may be recognized from the image. The mobile application will create an expense line using this extracted data.

Certain information may be defaulted or auto-populated for the expense entry. For example, the date and the location may be defaulted if the receipt image does not include this information. In addition, certain types of information may be auto-populated from the mobile device. For example, the location may be auto-populated using the GPS mechanism on the mobile device. In addition, the currency type may be auto-populated in the expense item based upon the mobile device location.

At 1910, the information for the expense line entry is displayed to the user. The user may, at 1912, either approve the entry or perform some type of correction to the entry. At 1913, the entry is locally saved to the mobile device. Thereafter, at 1914, the expense line entry is submitted to the server.

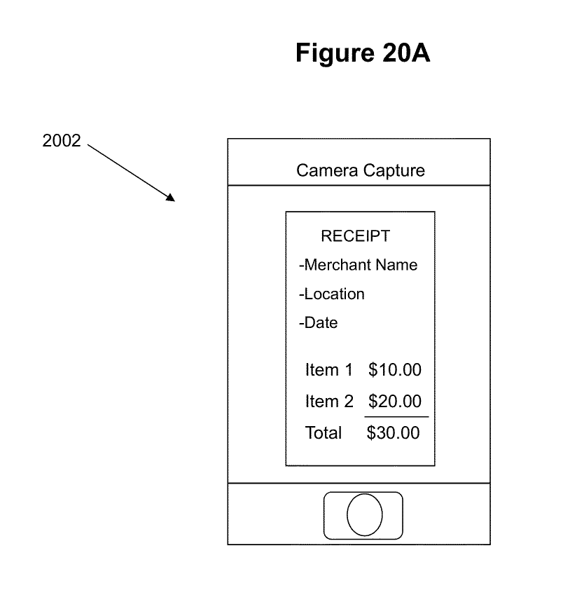

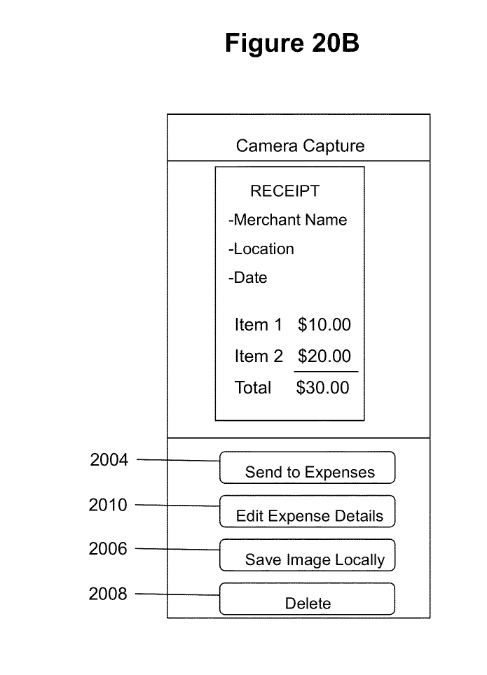

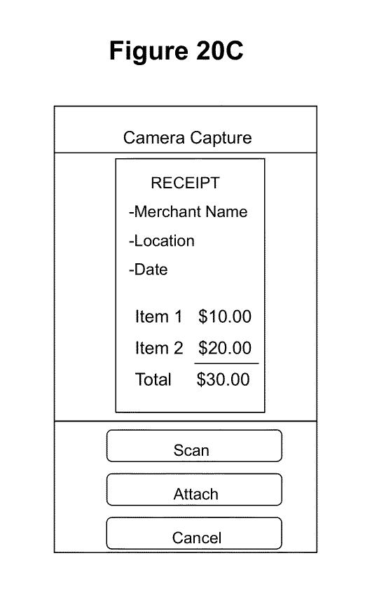

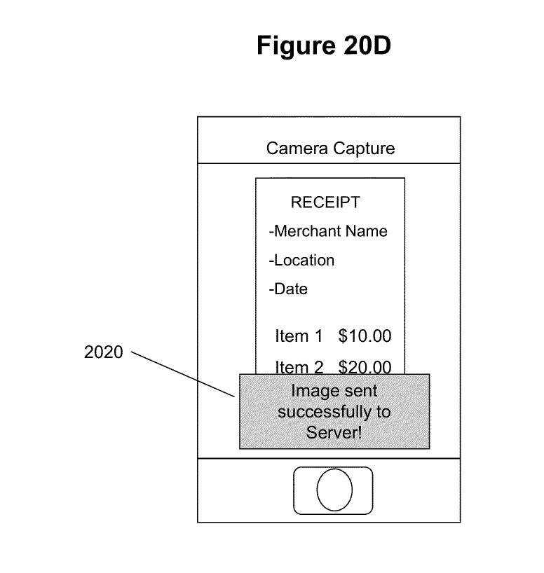

FIGS. 20A-C illustrate how the image capture mode for expense entry operates according to some embodiments of the invention. A camera icon in the springboard interface navigates the user to the camera mode 2002 shown in FIG. 20A, where the user can take a picture of the receipt. The user can choose to use the image for processing or has the option of retaking the picture.

As shown in FIG. 20B, if the user chooses to use the image, then the user will be shown interface elements for certain options. For example, the user may be given the option to scan the image, which will cause an OCR application to recognize text from within the image and to use that text to automatically create an expense line. The user may also be given the option 2006 to save the image locally, which will save the image in the local photo library of the mobile device. In addition, the user is given the option to cancel or delete the image/image operation. The user may also be given the option 2010 to edit the expense details. Finally, the user may be given the option 2004 to send the expense item to the server. The image data for the receipt may be sent with the expense entry to the server. In an alternative embodiment, the user is given the option of scanning or attaching the receipt, e.g., as shown in FIG. 20C. The line information is displayed to the user and the user can then approve the information. The line is saved and then sent to the server, e.g., as shown in “success” message of FIG. 20D.

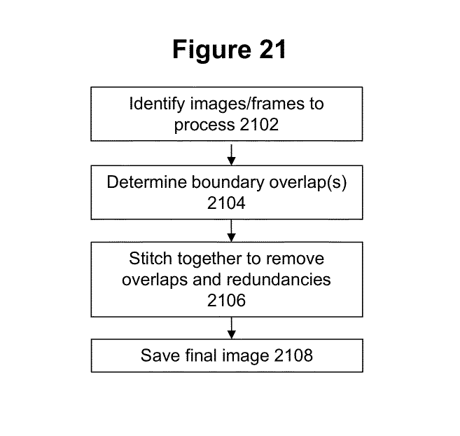

FIG. 21 shows a flowchart of an approach for stitching together multiple images/video frames. At 2102, the user identifies the multiple images or video to process. It is noted that the video (if digital) will include multiple video frames.

At 2104, boundaries and data overlaps are identified within the multiple images/frames. A determination is made of the receipt image that is to be used for processing. This action is taken by analyzing the image data on the images/frames, and checking for duplicative image elements. The proper boundaries for combining the images/frames would then be determined by eliminating the image duplications to create a consistent transition between the different images/frames.

Next, at 2106, the identified image boundaries are used as the locations to stitch together the different images/frames. At 2108, the final stitched-together image of the receipt is saved into a storage location.

Another task that must be performed for many employees is to track mileage data that is needed to file an expense report for mileage deductions/expenses. Given the strict requirements imposed by the government for this type of expense, the employee must be very diligent in including this correct information when preparing the expense line entries for an expense report. The problem is that this is normally a highly manual process that is very time-consuming and is prone to mistakes.

Embodiments of the invention provide much more efficient ways to track mileage data and to enter that data into expense line entries. Embodiments of the invention use the employee's mobile device that is integrated with the enterprise expense application to generate and provide this information.

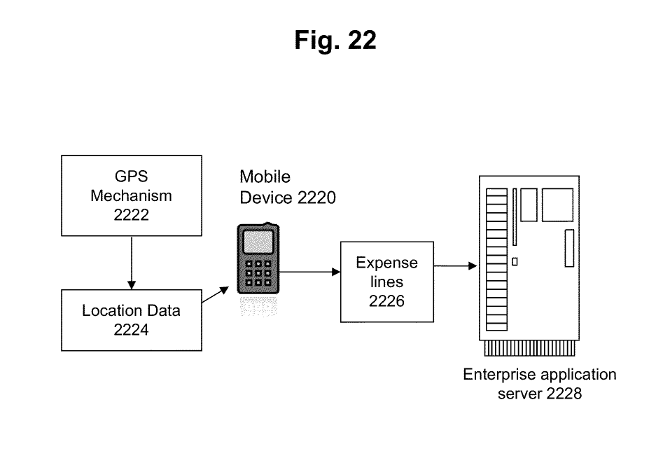

FIG. 22 illustrates a high-level diagram of this aspect of embodiments of the present invention. This figure shows that the mobile expense application on the mobile device 2220 may utilize a GPS mechanism 2222 on the mobile device 2220 to capture location data 2224 for the user. The location data 2224 provides an efficient set of data that can be processed to generate information for the expense entry 2226 which is sent to the enterprise application server 2228.

The advantage of this approach is that it provides a more efficient approach for entry of expense lines into an enterprise expense management application for mileage expenses which significantly reduces the amount of manual entry required by the user. Since expense reporting is an area that is performed by just about every company or organization in existence. The conventional approaches to enterprise management for mileage entry just does not allow for an efficient way to capture expenses that occur while the employee is out of the office. The present invention provides a very efficient solution to this problem.

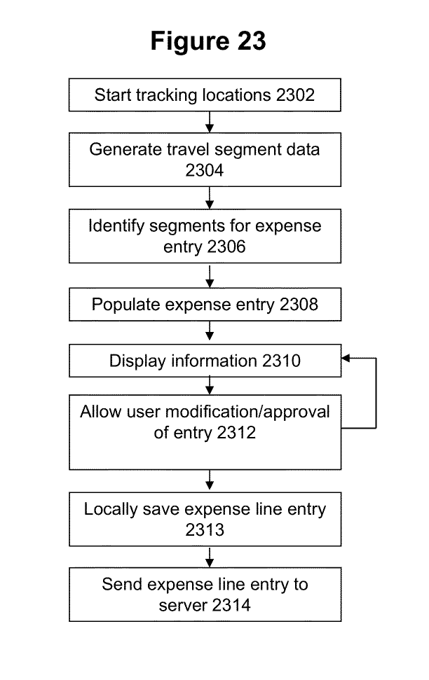

FIG. 23 shows a flowchart of an example procedure for implementing the mileage tracker approach of the invention. At 2302, the user begins tracking of location data. This may be initiated, for example, at the beginning of the day by a salesperson as he/she starts traveling in the morning.

The GPS device in the user's mobile phone would start generating location data for the mobile phone. The data would indicate periods of time that the mobile phone would spend in different physical locations. By checking the location data against a threshold time value, a determination can be made of periods of time in which the user was actually in transit, and periods of time in which the user was at a fixed location.

From this information, at 2304, segments can be created for the different trips that were made by the user over the course of the day. These segments can be identified based on information such as start location, start time, arrival location, arrival time, and/or mileage/distance travelled.

At 2306, the user would identify which of the segments pertains to a given trip which should be subject to an expense line entry. The selected segments would, at 1508, be combined together and used to populate an expense line entry with a combined mileage for the segments.

At 2310, the information for the expense line entry is displayed to the user. The user may, at 2312, either approve the entry or perform some type of correction to the entry. Thereafter, at 2314, the expense line entry is submitted to the server.

Therefore, what has been described is an improved approach for implementing an expense solution. Since mobile devices are integrated into the expense solutions architecture, this means that expense-related data can be captured, created, entered, and/or edited on the mobile device. This permits the user to generate expense line entries more in alignment with the location/way that many expense are actually generated, e.g., while the user is away from the office computer. Even while away from the office, the user will likely be with his/her mobile phone and it would be convenient for the user to be able to enter expense lines using the mobile device at, or very near, to the time/location at which the expense are actually being incurred, instead of waiting until the user returns back to the work computer to enter the expenses.

It is noted that the above inventive entry methods are not limited only to expense related applications. The novel aspects of the disclosed embodiments may also be applied to entry of information on mobile devices for other types of financial information as well. For example, the above-described entry approaches may be utilized to perform time entry for a time-management system. Therefore, the scope of the invention is not limited in its application only to expense-related functions.

### System Architecture Overview

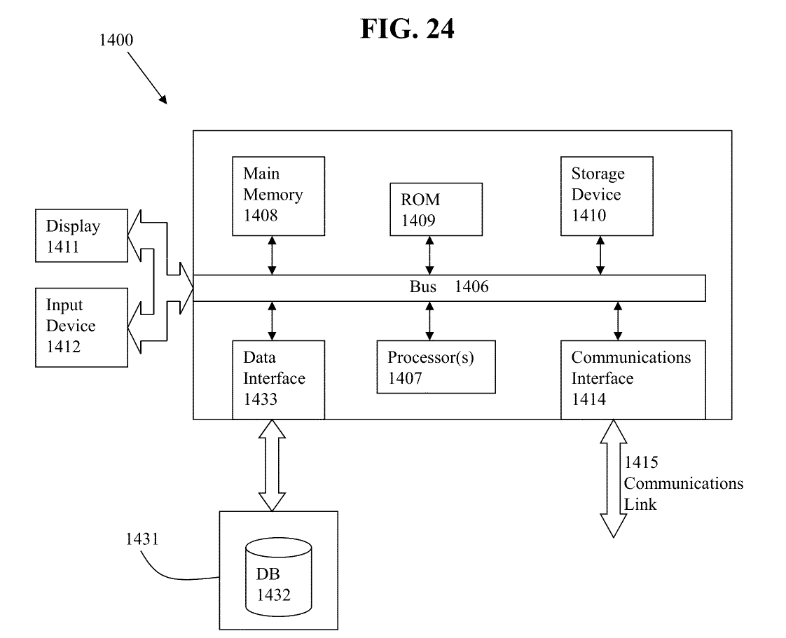

FIG. 24 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution. Computer system 1400 may communicate through a data interface 1433 to a database 1432 on an external storage device 1431.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

1. A method for performing expense item entry on a mobile device, comprising:
using at least one processor that is programmed or configured for performing a process, the process comprising:
generating an expense entry on a mobile device;
capturing location data pertaining movement of the mobile device;
tracking the movement of the mobile device to populate at least a portion of required fields for the expense entry;
determining another portion of required fields for the expense entry for which data is not entered;
auto-populating additional data for the other portion of required fields for the expense entry from a processing mechanism on the mobile device; and
sending the expense entry to a remote server comprising an enterprise expense application, such that the expense entry created on the mobile device is uploaded for processing at the enterprise server application, wherein the mobile device receives reference data generated by the remote server to allow the mobile device to process the expense entry in accordance with the enterprise expense application.

2. The method of claim 1 in which a mobile device hardware mechanism is used to capture the location data.

3. The method of claim 2 in which the mobile device hardware mechanism comprises a GPS mechanism.

4. The method of claim 1 in which time periods of the movement are tracked to identify transit periods and fixed location periods of the mobile device.

5. The method of claim 4 in which a threshold time value is configured to distinguish a transit period from a fixed location period.

6. The method of claim 1 in which travel segment data is generated for the mobile device.

7. The method of claim 6 in which the travel segment data comprises information including some or all of start location, start time, arrival location, arrival time, distance travelled.

8. The method of claim 6 in which identified travel segments are determined that pertain to a given trip.

9. The method of claim 8 in which distances are combined for the identified travel segments for the expense entry.

10. The method of claim 6 in which the mobile device comprises a mobile telephone or smartphone.

11. A computer program product embodied on a computer usable medium, the computer readable medium having stored thereon a sequence of instructions which, when executed by a processor causes the processor to execute a method for performing expense item entry on a mobile device, the method comprising:
generating an expense entry on a mobile device;
capturing location data pertaining movement of the mobile device;
tracking the movement of the mobile device to populate at least a portion of required fields for the expense entry;
determining another portion of required fields for the expense entry for which data is not entered;
auto-populating additional data for the other portion of required fields for the expense entry from a processing mechanism on the mobile device; and
sending the expense entry to a remote server comprising an enterprise expense application, such that the expense entry created on the mobile device is uploaded for processing at the enterprise server application, wherein the mobile device receives reference data generated by the remote server to allow the mobile device to process the expense entry in accordance with the enterprise expense application.

12. The computer program product of claim 11 in which a mobile device hardware mechanism is used to capture the location data.

13. The computer program product of claim 12 in which the mobile device hardware mechanism comprises a GPS mechanism.

14. The computer program product of claim 11 in which time periods of the movement are tracked to identify transit periods and fixed location periods of the mobile device.

15. The computer program product of claim 14 in which a threshold time value is configured to distinguish a transit period from a fixed location period.

16. The computer program product of claim 11 in which travel segment data is generated for the mobile device.

17. The computer program product of claim 16 in which the travel segment data comprises information including some or all of start location, start time, arrival location, arrival time, distance travelled.

18. The computer program product of claim 16 in which identified travel segments are determined that pertain to a given trip.

19. The computer program product of claim 18 in which distances are combined for the identified travel segments for the expense entry.

20. The computer program product of claim 11 in which the mobile device comprises a mobile telephone or smartphone.

21. A computer-based system for performing expense item entry on a mobile device, comprising:
a computer processor to execute a set of program code instructions;
a memory to hold the program code instructions, in which the program code instructions for generating an expense entry on a mobile device, capturing location data pertaining movement of the mobile device, tracking the movement of the mobile device to populate at least a portion of required fields for the expense entry, determining another portion of required fields for the expense entry for which data is not entered, auto-populating additional data for the other portion of required fields for the expense entry from a processing mechanism on the mobile device, and sending the expense entry to a remote server comprising an enterprise expense application, such that the expense entry created on the mobile device is uploaded for processing at the enterprise server application, wherein the mobile device receives reference data generated by the remote server to allow the mobile device to process the expense entry in accordance with the enterprise expense application.

22. The system of claim 21 in which a mobile device hardware mechanism is used to capture the location data.

23. The system of claim 22 in which the mobile device hardware mechanism comprises a GPS mechanism.

24. The system of claim 21 in which time periods of the movement are tracked to identify transit periods and fixed location periods of the mobile device.

25. The system of claim 24 in which a threshold time value is configured to distinguish a transit period from a fixed location period.

26. The system of claim 21 in which travel segment data is generated for the mobile device.

27. The system of claim 26 in which the travel segment data comprises information including some or all of start location, start time, arrival location, arrival time, distance travelled.

28. The system of claim 26 in which identified travel segments are determined that pertain to a given trip.

29. The system of claim 28 in which distances are combined for the identified travel segments for the expense entry.

30. The system of claim 26 in which the mobile device comprises a mobile telephone or smartphone.
